(19) United States
(12) Patent Application Publication
(10) Pub. No.: US 2015/0153491 A1
(43) Pub. Date: Jun. 4, 2015

(54) DIMMINGSHIELD

(71) Applicant: Danielle PRESTON, Palm Springs, CA (US)

(72) Inventor: Danielle PRESTON, Palm Springs, CA (US)

(21) Appl. No.: 13/933,400

(22) Filed: Dec. 4, 2013

(51) Int. Cl. G02B 5/23; B60J 3/04

(52) U.S. Cl. CPC G02B 5/23; B60J 3/04

(57) ABSTRACT

Dimming shield is designed to adapt the windshield of any motorized vehicle from clear to tint when exposed to direct sun light. Once the windshield is away from sunlight (for example the vehicle enters a parking garage or is outdoors after sunset) it will return to its clear state. The transition between clear and dark is gradual and is completed within a moment's time.

DIMMINGSHIELD is a motorized vehicle windshield that will darken on exposure to UV radiation. Once the motorized vehicle is removed from UV exposure the windshield will gradually return to a more opaque state. Ordinary glass has zero effect on UVA and UVB exposure. Glass has no UV inhibiting properties making it incredibly unsafe for passengers and drivers. The DIMMINGSHIELD will block UV rays as well as help diminish sun glare and other sun related inhibitors.

The windshield will achieve this darkening through the process of photochrome properties which is the embedding of microcrystalline silver halides or molecules in a glass substrate. With the photochrome material dispersed in the glass substrate, the degree of darkening will depend on the thickness of glass.

There are tints and automobile windows that block UV; however, these applications do not adjust to UV light. Some tints have polymer lacquer, which to the eye, is perfectly transparent absorbing very little radiation. Photochrome glass and tint will specifically filter out UV light and absorb 100% of UV radiation.

The DIMMINGSHIELD windshield will begin to darken within one minute in response to UV light and continue to slightly darken over a period of time depending on the amount of UV ray exposure. The DIMMINGSHIELD will begin to fade to its opaque state as soon as it is away from UV light and will be noticeably lighter within minutes and mostly clear within five minutes.

Photochrome compounds fade back to their clear state by a thermal process; the higher the temperature the less dark DIMMINGSHIELD will be, this thermal effect is called temperature dependency and prevents the windshield from achieving true glass darkness in very hot weather. This effect will also reverse Itself preventing total darkness in cold weather.

DIMMINGSHIELD will reduce the amount of infrared, visible light, and ultraviolet (UV) radiation entering windows. The DIMMINGSHIELD will convert incoming solar radiation to infrared radiation, which is then rejected back through the glass to the exterior. This can reduce energy loss by as much as 30-50 percent. Other benefits include protection for passengers in the rear, cooling for pets, greater privacy, reduced chance of theft (because valuables are less visible), reduced glare and reflection on liquid crystal display (LCD) screens, and protection for those who have conditions involving photosensitivity or skin sensitivity. The DIMMINGSHIELD also considered more effective and practical than stick-on blinds and sun visors. Recently many suits have been filed as a result of sun glare. Sun visors have proven to be an obstruction and ineffective for persons with disabilities or height restrictions.

1. A shield of glass, projecting above and across the dashboard of an automobile which contains a photochromic chemical reaction that causes a new molecular structure to absorb portions of visible light, causing the shield of glass to darken.
